(19) United States
(12) Patent Application Publication
(10) Pub. No.: US 2004/0099810 A1
(43) Pub. Date: May 27, 2004

(54) Ionising radiation detector with solid radiation conversion plate, and method for making same

(76) Inventor: Jean-Louis Gerstenmayer, Orsay (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/381,045

(22) PCT Filed: Jul. 24, 2002
(86) PCT No.: PCT/FR02/02649

(30) Foreign Application Priority Data
Jul. 26, 2001 (FR) 01 10003

(51) Int. Cl. H01J 47/00

(52) U.S. Cl. 250/389

(57) ABSTRACT

Ionising radiation detector with solid radiation conversion strip and manufacturing process for this detector.

This detector, that can for example be used in radiography, is formed by placing conversion means comprising the strip (10) and collection means (30) on each side of an excitable medium that interacts with charged particles resulting from the conversion of radiation (3), to generate other particles. The collection means collect these other particles and output signals representative of the radiation.

### TECHNICAL FIELD

The present invention relates to an ionising radiation detector and a manufacturing process for this detector.

The invention is particularly applicable to the detection of X-rays, gamma photons, protons and neutrons.

For example, the invention is applicable to the following fields:

fast non-destructive testing with very high spatial resolution,

positioning of patients in radiotherapy, with precision better than what is possible with detectors according to prior art, which enables a reduction of doses absorbed by patients,

radiography, and particularly medical radiography,

neutronography and

protonography.

### STATE OF PRIOR ART

Heterogeneous detectors called “calorimeters” are known in the field of particle physics, which is completely different from the fields mentioned above, and particularly from the radiography field, comprising a stack of metallic sheets alternating with elements made of a scintillating plastic material, for example connected to photodiodes or photomultipliers or to a light intensification tube.

These calorimeters are used simply for measuring total energies of incident particles, and do not have any spatial resolution and do not provide any image of an object.

Other heterogeneous detectors are also known that enable spatial resolution and that are used to determine the trajectory of incident particles. They comprise scintillating fibres that are at a spacing from each other, embedded in a lead matrix and for example read using a light intensification tube.

These other detectors are used to reconstruct the shape of the trajectory of each incident particle that penetrates laterally into such a detector, in other words perpendicular to the fibres of the detector rather than facing them (parallel to them), and not to supply an image of an object.

Ionising radiation detectors are also known that will interpret the image of an object transported by such radiation (in this case the word “object” should be understood in the broad sense of the term, considering a part of the human body or animal as being an object), are also known. It is frequently difficult to interpret or read this image.

In particular, high-resolution radiographic films are known that are used in non-destructive testing. But these films only supply an analogue image of an object.

Ionising radiation detectors are also known, comprising a metallic strip that is made of a material with a large cross section facing the incident radiation.

For example, a metal with an atomic number equal to at least 73 is used for the detection of X or γ photons, and a metal with a very low atomic number, usually less than 14, is used for the detection of neutrons, and other materials such as gadolinium can also be used for the detection of neutrons.

This metallic strip is immersed in an ionisable gaseous mix through which electrically conducting wires pass at a very wide spacing from each other, in order to form a wire chamber.

The principle of such a known detector is described below.

A high energy X or γ photon creates one or two photoelectrons in the detector strip by the Compton effect or by the pair creation effect, and puts them in fast movement (with a kinetic energy of the same order as the kinetic energy of the incident X or γ photon). This or these photoelectrons then ionise some molecules of the gas contained in the wires chamber.

Electrons torn off gas molecules under the effect of this ionisation are collected using an electric field and are thus made detectable due to the avalanche that occurs in a thin gas layer surrounding the detector wires.

The disadvantages of a wire chamber concerning amplification and reading are given below:

The detector has to be used in count mode, which limits the dose rate acceptable by this detector making it necessary to use a continuous X-ray source, for example comprising an electrostatic generator that is not as compact as existing LINACs with high frequency waves, and therefore requires more expensive radiological protection; several cubic meters of concrete have to be used for this protection.

The avalanche mentioned above takes place around the wires at a very large spacing in the chamber, which degrades the spatial resolution of the detector.

These wires have to be tightened, which causes very high mechanical tensions and it would be unthinkable to tighten a hundred times more wires.

These wires can start vibrating, which makes it necessary to use a vibration damper to stabilise the detector gain.

Furthermore, with this type of detector, the spatial resolution along a direction parallel to one edge of the metallic strip is fundamentally limited by the parallax phenomenon due to the propagation of primary photoelectrons within the thickness of gas located between the strip and the wires, a thickness that enables the creation of a sufficient number of ionisations in the gas so that detected particles (for example X photons or neutrons) can be counted by avalanche.

Furthermore, the resolution of such a detector is also limited by the distance between the wires contained in it, of the order of a few centimetres.

Furthermore, the maximum dose rate authorised by this detector is low due to the large distance between the wires and the detector cathode, which prevents fast elimination of the space charge due to the positive ions that accumulate in the wire chamber.

### PRESENTATION OF THE INVENTION

The purpose of this invention is to overcome the disadvantages mentioned above.

It proposes an ionising radiation detector capable of reading the image of an object transported by this radiation, more easily than known detectors mentioned above.

In particular, the invention proposes a detector that is better than the radiographic films mentioned above because this detector can be used to obtain a numeric image, instantaneously available and of better quality than the images obtained with these films, this detector being less sensitive to diffuse radiations while having a resolution at least as good as these films.

The invention also overcomes the disadvantages of detectors that use a wire chamber for the following reasons: the stopping capacity with respect to first ionising particles may be much higher, up to 1000 times higher at high energy (photons with energy of more than 10 keV).

Precisely, the purpose of this invention is an incident ionising radiation detector composed of first particles, this detector being characterised in that it comprises at least one elementary detector, or elementary detection subassembly, comprising:

means of converting first particles into second charged particles, these conversion means comprising at least a first strip made of a first solid material capable of converting the first particles into the second particles, this first strip being oriented such that the incident ionising radiation arrives on a first edge of this first strip and along this first edge, the depth of this fist strip measured from the first edge to a second edge of the first strip, opposite the first edge, being equal to at least one tenth of the mean free path of the first particles in the first material,

a medium that can be excited by the second particles, and that is capable of generating third particles representative of the incident ionising radiation, by interaction with these second particles, and

means of collecting these third particles, capable of outputting signals that are also representative of the incident ionising radiation.

According to one particular embodiment of the detector according to the invention, the first material is electrically conducting and the conversion means comprise a set of first strips in which micro-drillings are provided, these first strips being stacked and electrically insulated from each other, and the detector also comprises biasing means designed to bring these first strips to electrical potentials wich increase from one end of the set of the first strips to the other, and are designed to create an electric field capable of displacing the second particles towards the excitable medium.

According to one preferred embodiment of the detector according to the invention, the first material is resistive with a resistivity equal to or greater than about 10⁷ Ω.cm, a first face of the first strip is formed on an electrically conducting layer and the detector also comprises:

means of extracting the second particles, designed to extract these second particles from the first strip and sending them to the excitable medium, these extraction means comprising at least one second electrically conducting strip in which micro-drillings are provided, and formed on a second face of the first strip, opposite the first face of the first strip, the first and second strips having substantially the same depth and the same width, this width being measured from end to end along the first edge of the first strip, and

biasing means designed to bring the conducting layer and the second strip to different electrical potentials, creating an electric field capable of displacing the second particles towards the excitable medium.

Preferably in this case, the extraction means comprise a plurality of second strips that are electrically insulated from each other and form a stack provided with micro-drillings, and the biasing means are designed to bring the second strips to the electrical potentials which increase from one end of the set of second strips to the other, and are designed to displace the second particles towards the excitable medium.

Furthermore, in this preferred embodiment, a semi conducting material with a resistivity equal to or greater than about 10⁷ Ω.cm can be used as the first material.

This semi conducting material may be a semi conducting composite material comprising a host matrix of the electrically insulating polymer or semi conducting polymer type, and guest semi conducting type particles dispersed in this host matrix.

According to a first particular embodiment of the detector according to the invention, the excitable medium is a medium that can be ionised by the second particles, capable of generating electrical charges forming the third particles, by interaction with these second particles, this ionisable medium being substantially in the form of a third strip that is parallel to the first strip, these first and third strips having substantially the same depth and the same width, this width being measured from end to end along the first edge of the first strip, the collection means comprise a set of parallel electrically conducting bands electrically insulated from each other, these bands being capable of collecting electrical charges to output electrical signals representative of the incident ionising radiation, and the detector also comprises biasing means designed to create an electric field capable of displacing second particles from the conversion means to the ionisable medium and of displacing the electrical charges from this ionisable medium to the set of parallel bands.

This ionisable medium is preferably gaseous.

According to a second particular embodiment of the detector according to the invention, the excitable medium is capable of generating photons forming the third particles, by interaction with the second particles, this excitable medium being substantially in the form of a third strip parallel to the first strip, these first and third strips having substantially the same depth and the same width, this width being measured from end to end along the first edge of the first strip, and the collection means comprise parallel light guides, capable of collecting the photons to output light signals representative of the incident ionising radiation.

Preferably, in the detector according to the invention, the width of the first strip measured from end to end along the first edge of this first strip is equal to or greater than about 10 cm.

Also preferably, the thickness of this first strip is equal to or less than about 100 μm.

The detector according to the invention may comprise a plurality of elementary stacked detectors.

The present invention also relates to a process for manufacturing the detector according to the invention, in which the conversion means are formed and these conversion means and the collection means are put into place on each side of the excitable medium.

According to one particular embodiment of the process according to the invention, for manufacturing the preferred embodiment in which the first material is resistive, the conversion means are formed by forming the first strip on the electrically conducting layer and the second strip is fixed to the first strip.

### BRIEF DESCRIPTION OF THE DRAWINGS

This invention will be better understood after reading the description of example embodiments given below purely for information purposes and that are in no way restrictive, with reference to the appended drawings, wherein:

FIG. 1 is a diagrammatic perspective view of a detector according to the invention that detects the energy of an object transported by an ionising radiation,

FIG. 2 is a diagrammatic perspective view of a particular embodiment of the detector according to the invention, using a resistive conversion material,

FIG. 3 is a diagrammatic perspective view of another particular embodiment comprising several detectors like that in FIG. 2, stacked on each other,

FIG. 4 is a diagrammatic perspective view of another particular embodiment, using an electrically conducting conversion material, and

FIG. 5 is a diagrammatic perspective view of another particular embodiment, using a gas capable of emitting light when it is excited by charged particles, while the detectors in FIGS. 2 to 4 use an ionisable gas.

### DETAILED PRESENTATION OF PARTICULAR EMBODIMENTS

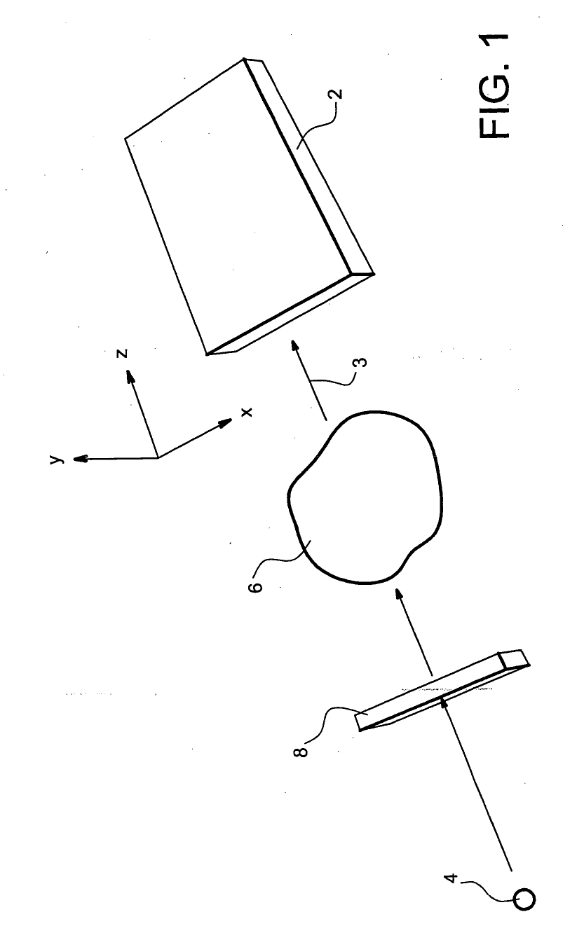

Detector 2 according to the invention, that is diagrammatically shown in FIG. 1, is designed to detect a penetrating high energy ionising radiation 3, for example composed of X photons or γ photons or protons or neutrons.

This detector converts the image transported by this radiation 3 into particles, for example electrons, which are easier to interpret than radiation.

These particles then excite a medium that may be a solid medium, for example a semi conducting, photo conducting, or a photovoltaic medium, or a gaseous medium.

The detector will then locally read the energy deposited by these particles to form an analogue type of image.

For example, this detector 2 can be associated with an ionising radiation source 4, this source being practically a point source. A radiographic image can then be formed of an object 6 inserted between the source 4 and the detector 2.

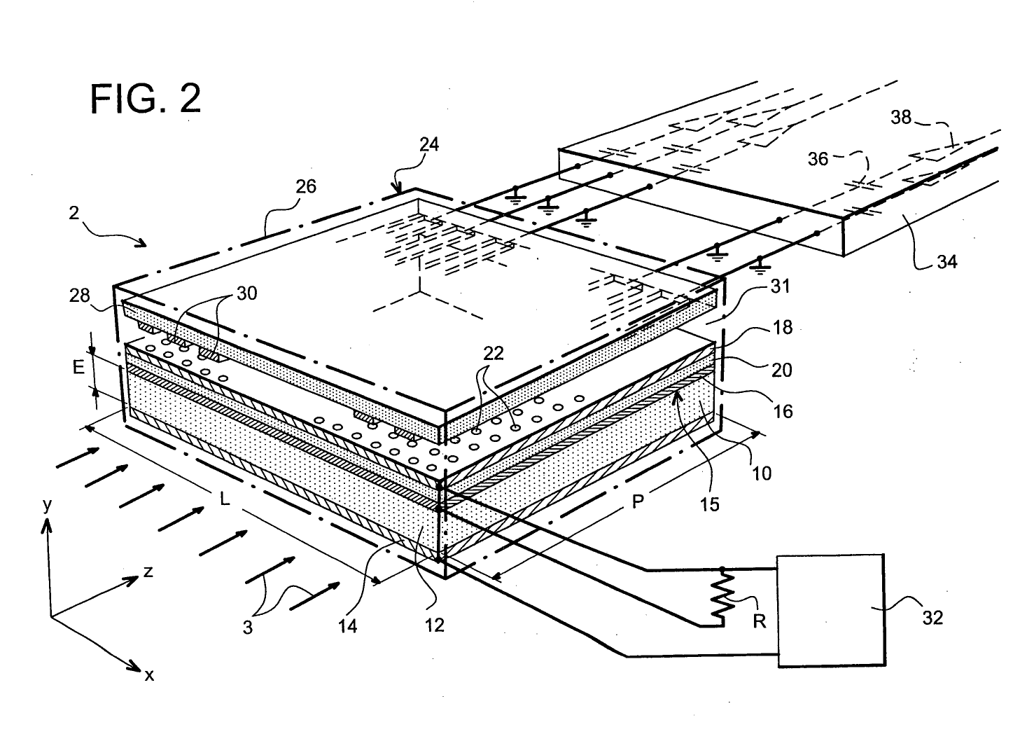

This detector 2, which has a plane approximately parallelepiped shape, is a stack of layers or strips, the structure of which is given in the description of FIG. 2.

The direction along which the radiation propagates is denoted z. The detector input face is placed along an x direction that is perpendicular to the z direction.

Note that a radiation collimator 8 is placed between the source 4 and the object 6 and is designed such that the radiation beam 3 that reaches the object 6 and then the detector is substantially plane and parallel to the xz plane.

The width of the detector is measured along the x direction. This width may be very large. It may be more than 1 metre.

The depth of the detector 2 is measured along the z direction and is large. This depth is greater than one tenth of the mean free path of the radiation in the material contained in the detector, and that will convert the image transported by the ionising radiation to achieve a high stopping capacity for this radiation.

This material, which will be described in more detail later, may be chosen to have a stopping capacity of more than 50%.

As will be seen better later, a very large number of detection pixels are formed and are aligned along the x direction (direction of the detector width).

The distance between two adjacent pixels may be very small, for example equal to 100 μm, which controls the spatial resolution of the radiographic image along the x direction.

The detector 2 is a linear detector and may be provided with a scanner function in order to perform a scanning function to finally obtain a two-dimensional image (like X-ray photographic material). For example, this scanning can be obtained by installing the connecting strap horizontally on a jack that moves it vertically.

The material enabling conversion of the incident ionising radiation (material that will be discussed again later) may be very thin. This thickness is measured along a y direction that is perpendicular to the x and z directions. This y direction is called the “scanning direction”.

The low thickness of the conversion material controls the spatial resolution of the radiographic image along the y direction parallel to scanning. A very small distance between the pixels controls the resolution along the x direction.

Furthermore, the low thickness reduces the sensitivity of the detector to parasite radiation, for which the pulse vector no longer passes through the source 4 due to diffusion of radiation in the various media encountered or passed through.

FIG. 2 is a diagrammatic perspective view of detector 2.

In the example in FIG. 2, this detector is designed for the detection of X-rays. It comprises an approximately parallelepiped-shaped strip made from a material that converts incident X-radiation into electrons. This material is resistive, with a resistivity equal to or greater than about 10⁷ Ω.cm.

The width, depth and thickness of the strip 10 are denoted L, P and E respectively. The depth P of this strip 10 is measured along the z axis parallel to the direction of incident radiation 3. Its width is measured along the x direction perpendicular to the z direction, and its thickness E is measured along the y direction perpendicular to the x and z directions.

The entry face of the detector 2 is on one edge 12 of the strip 10. This edge 12 is perpendicular to the z direction and parallel to the x direction. The strip 10 is parallel to the plane defined by the x and z directions and is oriented such that its edge 12 receives the approximately plane radiation beam 3 (that is also parallel to the xz plane).

The strip 10 of resistive material is formed on an electrically conducting layer 14 forming the cathode of the detector 2.

This detector 2 also comprises a stack 15 of electrically conducting layers that are electrically insulated from each other.

In the example shown, this stack comprises three layers with widths equal to approximately L and depths equal to approximately P, in other words two conducting layers 16 and 18 between which there is an electrically insulating layer 20. The conducting layer 16 is formed on the face of the strip of resistive material 10, opposite the face supported on the electrically conducting layer 14.

Furthermore, the stack has a large number of drillings 22, for example with a size of the order of 10 μm to 20 μm, and that are called “micro-drillings”.

Slits with dimensions of a few micrometers may be used instead of these micro-drillings.

Instead of the stack of layers 16 to 20, it would also be possible to simply use the conducting layer 16 with micro-drillings 22, but the stack of layers 16, 18 and 20 is preferable because this makes it possible to adjust the field in the holes and the field in the amplification volume by avalanche, independently.

The detector in FIG. 2 is placed inside a hermetically closed package 24 that contains a gas that can be ionised by electrons. As a variant, this package is provided with gas circulation and purification means (not shown).

This package 24 comprises a window 26 that is transparent to incident ionising radiation 3 and is facing the edge 12 of the strip of resistive material 10 on which this radiation 3 arrives.

For example, it would be possible to use an aluminium window, or a window made of other materials if necessary.

The detector 2 also comprises an electrically insulating strip 28, one face of which is provided with equidistant electrically conducting tracks 30 parallel to each other. The face on which these tracks are placed faces the conducting layer 18 of the stack.

As can be seen in FIG. 2, the insulating strip 28 is parallel to the xz plane and the conducting tracks 30 are parallel to the z direction.

A space 31 is provided between the stack of layers 16, 18 and 20 and the insulating strip 28. This space, with a width equal to approximately L and a depth equal to approximately P, is filled with the gas contained in the package 24 (or circulating in this package). This gas can then be ionised by electrons that can exit from micro-drillings 22 as will be seen later.

The detector 2 is provided with polarisation means 32 for the layers 14, 16 and 18 and tracks 30, in order to bring the potential of the conducting layer 14 to a value lower than the potential of the conducting layer 18, which is itself lower than the potential of each of the conducting tracks 30, the potential of the intermediate conducting layer 16 being brought to an intermediate value between the corresponding potentials of the conducting layers 14 and 18 joining layers 16 and 18 through an electrical resistance R with an appropriate value.

In the example shown in FIG. 2, the micro-tracks 30 are grounded, the potential of the conducting layer 18 is negative and the potential of the conducting layer 14 is even more negative.

During operation of the detector 2, the radiation 3 interacts with the material of strip 10. Electrons are thus generated in this material. Taking account of the chosen potentials, these electrons are extracted from the material of the strip by means of the stack of layers 16 to 18 and pass through the micro-drillings 22 in this stack.

These electrons then interact with the ionisable gas contained in the space between the stack and the tracks 30, which creates other electrons and if necessary avalanches of these other electrons (the gain of 1 to 10⁵ being adjustable). Electrons generated in the ionisable gas are then collected by the conducting tracks 30.

These tracks are narrow, for example of the order of 1 μm wide, and thus form micro-tracks. They are also very close to each other; for example they may be at a spacing of 100 μm from each other.

These micro-tracks 30 collect electrons and as a result output signals that are detected due to appropriate electronic processing means 34 or a read circuit.

At the input to these electronic processing means 34, there is a capacitor 36 and a fast operational amplifier 38, for each micro-track 30. Each capacitor 36 is connected firstly to the corresponding micro-track 30 and secondly to the corresponding operational amplifier 38.

Note that micro-perforations or slits compress the electrostatic field lines that start from the conducting layer 14. Reducing the distance between the field lines that guide electrons to be collected causes a local increase in the electric field. As a result of this increase, electrons are extracted from the strip 10 and injected in the ionisable gas.

Furthermore, a physical amplification (gain by avalanche) is useful to compensate for the small number of ionisation charges generated by primary photoelectrons when they pass through the low thickness (for example 100 μm) of strip 10.

This low thickness avoids parallax problems that degrade the spatial resolution of the detector in the x direction, since the photoelectrons make a given angle with the direction of the radiation to be detected.

Furthermore, this low thickness makes it possible to use an inexpensive read circuit 34.

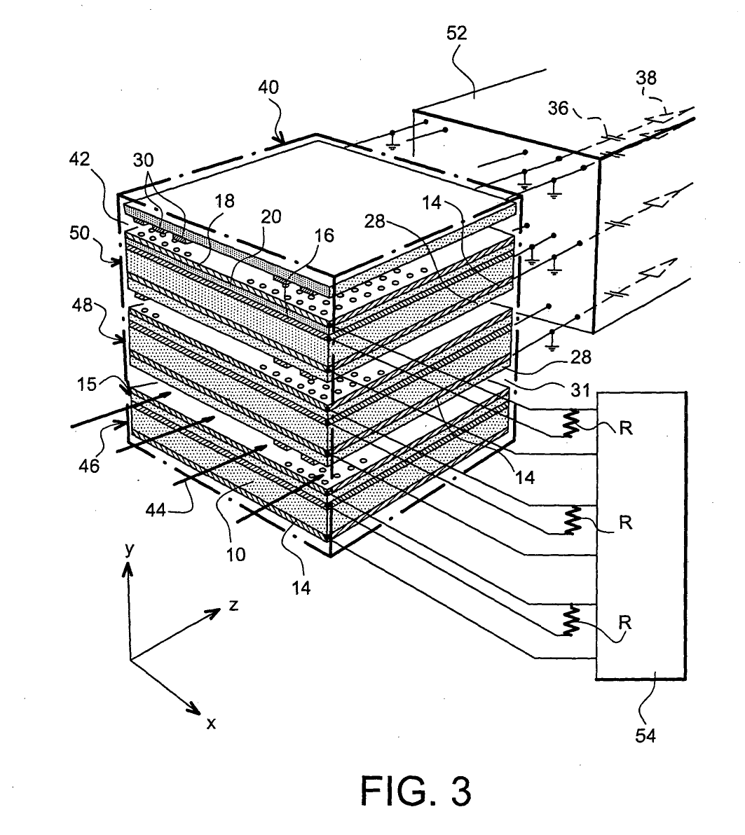

The detector according to the invention, which is shown diagrammatically in a perspective view in FIG. 3, is a matrix type detector. This detector in FIG. 3 is a stack of detectors like that shown in FIG. 2. Three detectors of this type are used in the example in FIG. 3.

More precisely, the detector in FIG. 3 can also be placed in a package 40 containing the ionisable gas and is provided with an inlet window 42 transparent to the radiation to be detected, for example X radiation marked as reference 44 in FIG. 3.

This detector in FIG. 3 comprises three stacked elementary detectors 46, 48 and 50 like that shown in FIG. 2.

The first elementary detector 46 comprises the conducting layer 14, the strip of resistive material 10, the stack 15 of conducting layers separated by an insulating layer and provided with micro-drillings 22, the space 31 containing ionisable gas, and the electrically insulating strip 28 supporting the electrically conducting micro-tracks 30.

The second elementary detector 48 is placed on this first elementary detector 46. The conducting layer 14 of this second elementary detector is supported on the electrically insulating strip 28 of the detector 46.

The composition of this second detector 48 is the same as detector 46, and so is the third elementary detector 50, for which the conducting layer 14 is formed on the electrically insulating strip 28 of the second elementary detector 48.

The result is thus a matrix of conducting micro-tracks 30 that is connected to appropriate electronic processing means 52.

The detector in FIG. 3 is provided with polarisation means 54 to adjust the potential of each conducting layer 14 to make it less than the potential of the associated conducting layer 18, this potential itself being less than the potential of the associated micro-tracks 30, these micro-tracks being grounded in the example shown, the associated intermediate conducting layer 16 also being adjusted to a potential intermediate between the potentials of the conducting layers 14 and 18 as a result of an appropriate electrical resistance R.

There are still the capacitors 36 and fast operational amplifiers 38 at the input to the electronic means 52, to which the micro-tracks 30 are connected as described above.

Note that spacers (not shown), are provided in the example shown in FIGS. 2 and 3 to keep an appropriate distance between each insulating strip on which the conducting micro-tracks are supported, and the micro-perforated conducting layer facing it.

A strip of a solid ionisable material such as silicon, AsGa or ZnS could be used instead of the space 31 filled with ionisable gas. However, the ionisable gas is preferable because the avalanche will not deteriorate the gaseous amplifying material.

The strip 10 could be made of a porous semiconductor such as caesium iodide in the form of small needles.

A thin diamond layer could also be used formed by chemical vapour phase deposition, or any other resistive semiconductor such as CdTe, ZnTe, AsGa, InP, crystalline Si or amorphous Si could also be used.

However, it is preferred to use a composite semiconductor that can easily be deposited using a layering technique (as would be done for paint), which significantly reduces the cost of the detector.

This type of composite semi conducting material comprises an insulating or semi conducting polymer forming a host matrix in which semi conducting particles forming the guest particles are dispersed.

For example PPV (polyphenylenevinylene), polythiophene, polyaniline, polypyrrole or polydiacetylene could be used as the semi conducting polymer.

Isooctane could be used for the insulating polymer.

The guest particles that are input into the host matrix have a high stopping capacity for the incident radiation. They perform two functions, to capture this radiation and to convert it into electrons.

Considering their function, the average atomic number, the average density and the average relative permittivity should be greater than the average atomic number, the average density and the average relative permittivity of the polymer.

Preferably, guest particles with an average atomic number of more than 14 would be used, with an average density of more than 2 g/cm³ and an average relative permittivity of more than 10.

These guest particles would preferably be derived from a semiconductor powder (for example CdTe, ZnS, ZnSe or ZnTe), for which the grain sizes are of the order of 1 nm to 100 μm, or even colloidal particles of this semiconductor.

It would even be possible to use grains of mixes of different semiconductor powders, possibly with different size gradings.

A layer of a composite semi conducting material may be produced in several ways.

For example it would be possible to start from an electronically suitable semiconductor already in the powder state (this type of semiconductor is commercially available).

The polymer that will be used to form the host matrix is firstly dissolved in a solvent, for example toluene, and is then mixed with the semiconductor powder, for example using a drum, a mixer-granulator or a granulating tray. A single sedimentation may even be sufficient and excess solvent will be poured on and the remaining solvent will then be allowed to evaporate. The mechanically prepared homogeneous mix can be spread. The solvent then evaporates and leaves a composite layer that may be a few hundred micrometers thick.

As a variant, the semiconductor powder is mixed with an added anti-lumping agent compatible with the monomer that will be used to form the host matrix, and this monomer traps the semiconductor grains as it polymerises.

Other industrial techniques can be used to bind a powder (for example by dissolution or dispersion or by humidification of this powder) or compacting techniques (such as those used to form tablets) or even extrusion techniques can be used to obtain the layer of composite semi conducting material.

The mix of the semiconductor powder and polymer dissolved in a volatile solvent may also be sprayed on a complex and/or very large surface, as in the case for paint with a spray gun.

The right stoichiometric semi conducting compound can be formed starting from powder constituents of a semi conducting material, by fusion at high temperature. This can be done using any “fast solidification” technique for powders as in the case of freeze drying (for example using a rotating drum or disk or atomisation in a gas current). The powder can then be recovered dry and then treated as described above to form the layer of composite material, or it can be entrained directly by the polymer (or monomer) solution.

Powder vapour phase synthesis techniques can also be considered (for example cracking, chemical vapour phase deposition or spraying in a plasma). In some cases, the deposition may be made on a cooled substrate capable of supporting the monomer or the polymer in solution, or by simultaneous evaporation of organic molecules that will form the polymer host matrix.

A technique for simultaneous spraying of the semiconductor powder can also be used using a gas current, for example a nitrogen current, entraining more or less molten semiconductor droplets produced by means of a plasma torch, and polymers also in droplet form.

Guest particles of a semiconductor can also be added into a host matrix forming an aerogel and containing a small or large quantity of polymer using a wet method or a sol-gel process.

We will now describe an example detector according to the invention of the type shown in FIG. 2, purely for information and in no way restrictive.

The conversion material from which the strip 10 is made consists of a semiconductor powder, for example CdTe, with a high intrinsic resistivity, this powder being sintered or placed in a semi conducting polymer binder such as polypyrrole, to form an 80 μm thick, 20 cm deep and 50 cm wide band.

As a variant, a powder of a semiconductor such as PbI₂ is used that will be deposited in vapour phase to form such a band.

The dimensions given above may be reduced if necessary, considering that it is technically feasible to make pixels with a 50 μm pitch.

A set 15 of three layers (a metallic layer or electrode 16—a plastic layer 20—a metallic layer or electrode 18) is then deposited directly on this conversion material, this set of three layers being approximately plane, and the micro-perforations 22 are formed through this assembly by photo-etching.

As a variant, a sheet with three layers (metal-insulator-metal) is epitaxied onto the strip 10 of the conversion material through which micro-perforations pass, this sheet being made in advance.

The diameter of the micro-perforations is about 25 μm and the spacing between them is about 30 μm to 50 μm.

A potential difference varying from a few volts to a few hundred volts can be applied between the set of three layers, in order to flexibly control the squeezing of the derivative field lines and therefore the electrons extraction electric field.

If the electric field in the micro-perforations 22 becomes high, a gain by avalanche is achieved in these micro-perforations 22 that can act as an optional pre-amplification.

With the detector in this example given purely for information purposes and that is in no way restrictive, almost all the detected X-rays (for which the spectrum extends for example between 1 MeV and 5 MeV) contribute to the measured signals if a semiconductor with a low darkness current is used, provided that it is highly resistive like CdTe, diamond, CdZnTe and ZnS. Such a detector may then be considered to be a quantum detector.

A printed circuit formed on a ceramic may be used to supply power to this detector with electrical voltages of up to 500 V, considering that the electrical connections are close to each other.

We will now describe an example of a manufacturing process for such a detector.

The strip 10 of conversion material may be made using any appropriate process.

The lower face of this strip 10 is coated with a metallic layer forming the layer 14 and that can create a pure resistive contact with the strip 10 of conversion material. For example, a gold coat could be used.

One method of proceeding is described below:

1° A 50 μm thickness of an appropriate semiconductor, for example CdTe, is deposited on one of the faces of a gold sheet, for example by CVD (chemical vapour deposition), epitaxy or pouring.

2° A three layer metal-plastic-metal sheet with micro-perforations, possibly formed by chemical attack, is fixed to the strip of conversion material thus obtained, for example using a conducting glue.

For example, a Kapton (registered trademark) type of plastic material may be used to form the intermediate insulating layer 20.

3° Electrically insulating means are used to fix an electrically insulating strip 28 on which conducting tracks 30 are provided typically at a spacing of 100 μm from each other, to the assembly thus obtained, while providing a predefined thickness of ionisable gas to obtain an avalanche phenomenon, through the use of electrically insulating cylindrical studs and electrically insulating spacers (for example forming balls, filaments, a honeycomb structure or a highly cellular foam).

Further information about this space containing ionisable gas may be obtained by reference to documents [1] and [2] mentioned at the end of this description.

Action may be taken such that the micro-tracks 30 project a few micrometers beyond the insulating plate 28 to overlap an edge of this plate, to enable an electrical link to the read circuit 30.

This read circuit may be an ASIC (Application Specific Integrated Circuit) such as CCD read chips, for example like those marketed by the EG & RETICON Company or the THOMSON Company.

An electric field of the order of 1000 V/mm or 5000 V/mm can be set up between the top face of the three layer assembly 15 and the plane of conducting micro-tracks tracks 30 to create an electric field conducive to avalanche amplification and to collect electrons.

The micro-tracks are connected to the pins of the integrated read circuit, for example by bonding using solder balls or by wires or pressure (or soldering), or even by bonding using an electrically conducting glue.

If necessary, a connector could be used to make the pitch of the tracks match the pitch of the pins on the read chip (ASIC).

Preferably, a connection with a flexible part will be used that will move the ASIC circuit away from the collimated X-ray flux.

Returning to the detector in FIG. 2, note that the thickness and width of the strip 10 are chosen to optimise the spatial resolution of the detector 2 and the conversion efficiency of this detector.

An attempt is made to use the thinnest possible strip 10, typically less than 100 μm thick, which is why it is advantageous to amplify the number of electrons generated before the corresponding electrical signals are read, using a physical phenomenon.

With the detector 2 according to the invention, the constraints limiting the resolution and the weakness of the dose rate mentioned above with respect to known wire chambers no longer exist, and if a sufficient number of electrons is extracted from the strip 10, a very thin and preferably gaseous amplification means can be used to avoid degrading the required spatial resolution.

Therefore, a significant number of electrons can be detected very close to the detected interaction point, which guarantees the spatial resolution.

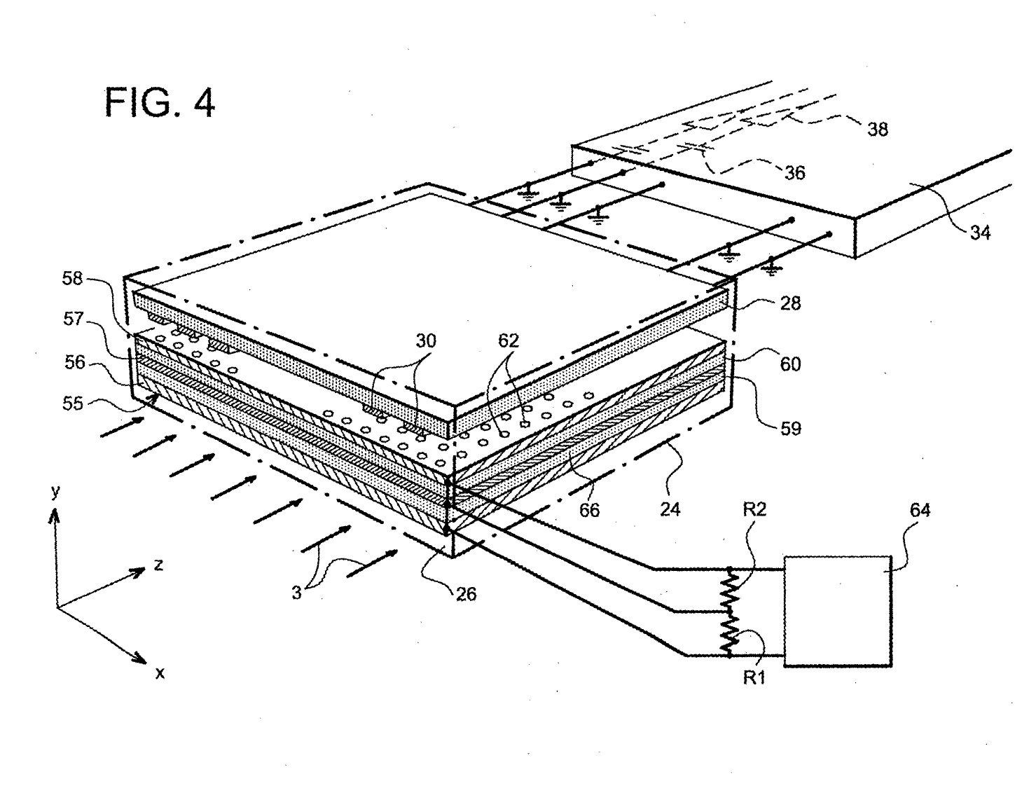

The detector according to the invention, which is shown diagrammatically in a perspective view in FIG. 4, is different from the detector 2 in FIG. 2 in that the assembly formed by the strip of resistive material 12, the conducting layer 14 and the set of three layers 16, 18 and 20 in this detector 2 is replaced by a stack 55 of layers of an electrically conducting material capable of converting incident X radiation into electrons, these layers being separated from each other by electrically insulating layers, for example made of an oxide of the same metal (anodisation).

In the example shown in FIG. 4, three electrically conducting layers 56, 57 and 58 and two electrically insulating layers 59 and 60 are used, that separate these layers 56, 57 and 58 from each other.

This set of conducting layers alternating with insulating layers is provided with micro-perforations 62.

As shown in FIG. 4, the layer 58 is the layer facing the micro-tracks 30.

Polarisation means 64 are used to adjust the potential of the conducting layer 56 to make it less than the potential of the conducting layer 58, which itself is less than the potential of the micro-tracks 30.

In the example shown, these micro-tracks are grounded and the potential of the conducting layer 57 is adjusted to a potential intermediate between the corresponding potentials of the conducting layers 56 and 58. This is done by connecting the conducting layer 57 to the conducting layers 56 and 58 by appropriate electrical resistances R₁ and R₂.

Further information in this respect can be found in document [3] at the end of this description.

Document [4] also mentioned at the end of the description, also provides further information.

Incident X-rays on the edge 66 of the stack 55 (corresponding to the edge 12 of the strip 10) also generate electrons that pass through the micro-drillings 62 and ionise the gas between the conducting layer 58 and the electrically insulating strip 28 on which the micro-tracks 30 are supported, by interacting with the material in layers 56, 57 and 58.

The electrons generated in the ionised gas may also be detected by these micro-tracks and these micro-tracks output electrical signals that are read by the electronic processing means 34.

Note that the micro-perforations 62 (that could be replaced by micro-slits a few micrometers long) can be used to extract electrons from the stack 55 by minimising the parallax between an interaction point of X-radiation and the exit point of the electrons generated by this interaction.

Two or more of the detectors like those shown in FIG. 4 (placed in the same package) can be used to obtain a matrix detector of the type of detector shown in FIG. 3.

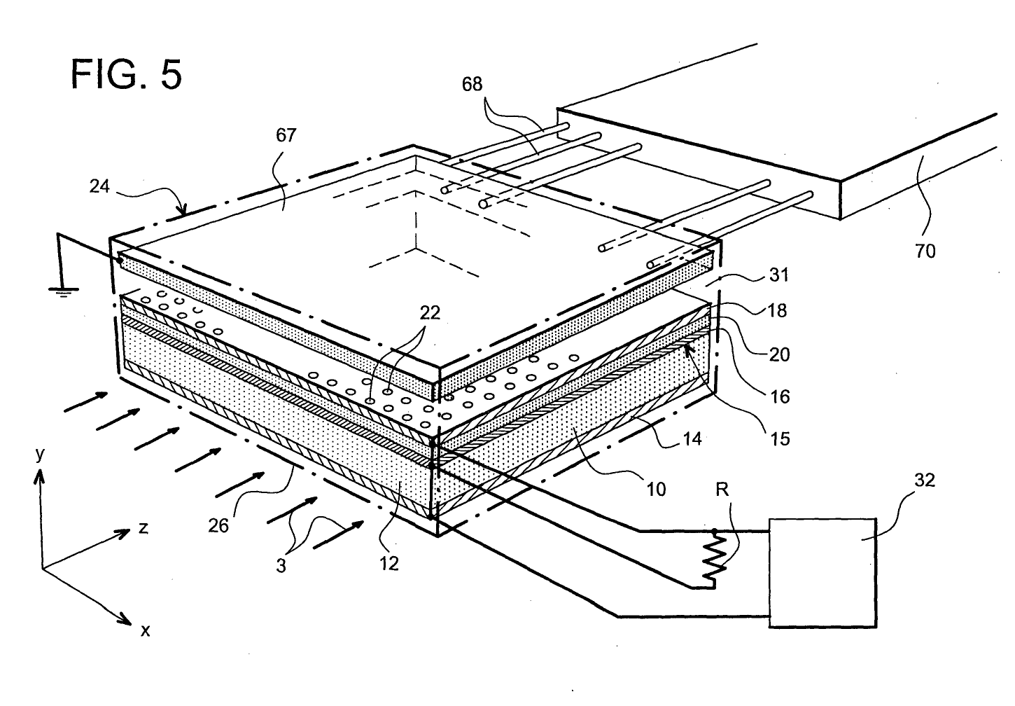

The detector according to the invention which is diagrammatically shown in a perspective view in FIG. 5, is different from the detector in FIG. 2 in that the strip 28 on which the micro-tracks 30 are supported is eliminated.

The space 31 is delimited by the stack 15 and an electrically conducting strip 67 parallel to the xy plane is grounded.

In the case shown in FIG. 5, the ionisable gas in FIG. 2 is replaced by a gas, for example a gaseous mix of argon/dimethylether/triethylamine, that can emit light due to an interaction with electrons emerging from micro-drillings 22 in the assembly 15.

The ends of the optical fibres 68 are placed equidistant and parallel to each other and to the z direction of the X-radiation to be detected, on the detector side, opposite the side through which the X-radiation to be detected arrives, and within the gas thickness.

The other ends of these optical fibres are connected to an electronic camera 70, for example a CCD or CID type camera, or to a camera in which an amorphous silicon matrix is formed.

Light emissions from the gas contained in the space 31 are picked up by optical fibres 68 and form an analogue form of the image transported by the radiation to be detected 3.

These light signals transported by the fibres are read by the camera 70.

Two or more than two detectors of the type shown in FIG. 5 can be stacked (placed in the same package) to obtain a matrix detector of the type of the detector shown in FIG. 3.

In this case, electrical insulation means are provided, for example an electrically insulating layer between two adjacent detectors without the need for any contact between a layer 14 and an adjacent strip 67.

Other detectors conform with the invention can be obtained by replacing the assembly consisting of the layer 14, the strip 10 and the stack 15 in FIG. 5 by the stack 55 in FIG. 4. These other detectors may be stacked (in the same package) to form a matrix detector.

The invention is not limited to detection of X or photons; for example, it is applicable to the detection of neutrons using a strip of plastic material to interact with these neutrons, then supplying protons.

These protons then interact with the electrons in the medium or the nuclei of atoms to give particles (electrons, nuclei) that are detected by the ionisation trace that they deposit in the detector medium, as before.

The following documents are referenced in this description:

[1] Détecteur de position, à haute resolution, de hauts flux de particules ionisantes (High resolution position detector for high fluxes of ionising particles), invention by Georges Charpak et al., international patent application No. WO 97/14173, published on Apr. 17, 1997.

[2] Détecteur de particules à electrodes multiples et procéde dé fabrication de ce detecteur (Particle detector with multiple electrodes and process for manufacturing this detector), invention by Georges Charpak et al., European patent application No. EP0872874 published on Oct. 21, 1998.

[3] Détecteur bidimensionnel de rayonnements ionisants et procede de fabrication de ce détecteur (Two-dimensional ionising radiation detector and manufacturing process for this detector), invention by Jean-Louis Gerstenmayer, French patent application No. EN 9902289, published on Feb. 24, 1999.

[4] Détecteur bidimensionnel de rayonnements ionisants et procéde dé de fabrication de ce détecteur (Two-dimensional ionising radiation detector and manufacturing process for this detector), invention by Jean-Louis Gerstenmayer, French patent application No. EN 9904725, published on Apr. 15, 1999.

1. Incident ionising radiation detector composed of first particles, this detector being characterised in that it comprises at least one elementary detector comprising:
means (10; 56, 57, 58) of converting first particles into second charged particles, these conversion means comprising at least a first strip made of a first solid material capable of converting the first particles into the second particles, this first strip being oriented such that the incident ionising radiation arrives on a first edge (12) of this first strip and along this first edge, the depth of this fist strip measured from the first edge to a second edge of the first strip, opposite the first edge, being equal to at least one tenth of the mean free path of the first particles in the first material,
a medium that can be excited by the second particles, and that is capable of generating third particles representative of the incident ionising radiation, by interaction with these second particles, and
means (30, 68) of collecting these third particles, capable of outputting signals that are also representative of the incident ionising radiation.

2. Detector according to claim 1, in which the first material is electrically conducting and the conversion means comprise a set of first strips (56, 57, 58) in which micro-drillings (62) are provided, these first strips being stacked and electrically insulated from each other, and the detector also comprises biasing means (64) designed to bring these first strips to electrical potentials which increase from one end of the set of the first strips to the other, and are designed to create an electric field capable of displacing the second particles towards the excitable medium.

3. Detector according to claim 1, in which the first material is resistive with a resistivity equal to or greater than about 10⁷ Ω.cm, a first face of the first strip (10) is formed on an electrically conducting layer (14) and the detector also comprises:
means (16, 18) of extracting the second particles, designed to extract these second particles from the first strip and sending them to the excitable medium, these extraction means comprising at least one second electrically conducting strip (16, 18) in which micro-drillings (22) are provided, and formed on a second face of the first strip (10), opposite the first face of the first strip, the first and second strips having substantially the same depth and the same width, this width being measured from end to end along the first edge of the first strip, and
biasing means (32) designed to bring the conducting layer and the second strip to different electrical potentials, creating an electric field capable of displacing the second particles towards the excitable medium.

4. Detector according to claim 3, in which the extraction means comprise a plurality of second strips (16, 18) that are electrically insulated from each other and form a stack provided with micro-drillings (22), and the biasing means (32) are designed to bring the second strips to electrical potentials which increase from one end of the set of second strips to the other, and are designed to displace the second particles towards the excitable medium.

5. Detector according to any one of claims 3 and 4, in which the first material is a semi conducting material with a resistivity equal to or greater than about 10⁷ Ω.cm.

6. Detector according to claim 5, in which this semi conducting material is a semi conducting composite material comprising a host matrix of the electrically insulating polymer or semi conducting polymer type, and guest semi conducting type particles dispersed in this host matrix.

7. Detector according to any one of claims 1 to 6, in which the excitable medium is a medium that can be ionised by the second particles, capable of generating electrical charges forming the third particles, by interaction with these second particles, this ionisable medium being substantially in the form of a third strip that is parallel to the first strip, these first and third strips having substantially the same depth and the same width, this width being measured from end to end along the first edge of the first strip, the collection means comprise a set of parallel electrically conducting bands (30), electrically insulated from each other, these bands being capable of collecting electrical charges to output electrical signals representative of the incident ionising radiation, and the detector also comprises biasing means designed to create an electric field capable of displacing the second particles from the conversion means to the ionisable medium and of displacing the electrical charges from this ionisable medium to the set of parallel bands.

8. Detector according to claim 7, in which the ionisable medium is gaseous.

9. Detector according to any one of claims 1 to 6, in which the excitable medium is capable of generating photons forming the third particles, by interaction with the second particles, this excitable medium being substantially in the form of a third strip parallel to the first strip, these first and third strips having substantially the same depth and the same width, this width being measured from end to end along the first edge of the first strip, and the collection means comprise parallel light guides (68), capable of collecting the photons to output light signals representative of the incident ionising radiation.

10. Detector according to any one of claims 1 to 9, in which the width (L) of the first strip measured from end to end along the first edge of this first strip is equal to or greater than about 10 cm.

11. Detector according to any one of claims 1 to 10, in which the thickness (E) of the first strip is equal to or less than about 100 μm.

12. Detector according to any one of claims 1 to 11, comprising a plurality of elementary stacked detectors (46, 48, 50).

13. Method for manufacturing the detector according to any one of claims 1 to 12, in which the conversion means (10; 56, 57, 58) are formed and these conversion means and the collection means are put into place on each side of the excitable medium.

14. Method according to claim 13, for manufacturing the detector according to claim 3, in which the conversion means are formed by forming the first strip (10) on the electrically conducting layer (14) and the second strip (16, 18) is fixed to the first strip.
